(19) United States
(12) Patent Application Publication
(10) Pub. No.: US 2007/0227717 A1
(43) Pub. Date: Oct. 4, 2007

(54) Method and system for controlling an automotive multizone HVAC system

(76) Inventors: Mark David McBroom, Northville, MI (US); Chris George Oehring, Monroe, MI (US); Chuck Pham, Canton, MI (US); John David Hoeschele, Canton, MI (US)

Correspondence Address: VISTEON, C/O BRINKS HOFER GILSON & LIONE, PO BOX 10395, CHICAGO, IL, 60610, US

(21) Appl. No.: 11/605,786

(22) Filed: Nov. 28, 2006

Related U.S. Application Data
(63) Continuation-in-part of application No. 10/354,841, filed on Jan. 30, 2003, now abandoned.

(51) Int. Cl. B60H 1/00

(52) U.S. Cl. 165/203

(57) ABSTRACT

A method for controlling the temperature of two or more zones inside a vehicle using an HVAC system. In one aspect, a method for controlling temperature inside a vehicle is provided that comprises determining a power required to control the temperature of a first zone of the vehicle and determining a discharge air temperature for one of the first zone and a second zone of the vehicle based on a mass transfer between the first zone and a second zone of the vehicle. In another aspect, a method for controlling temperature inside a vehicle is provided that comprises determining a power required for a first zone and a third zone of the vehicle, determining a mass transfer in a second zone of the vehicle, and determining a discharge temperature for one of the first zone, second zone, and third zone of the vehicle based on a mass transfer between two zones of the vehicle.

### CROSS REFERENCE TO RELATED APPLICATIONS

This application is a continuation-in-part of U.S. patent application Ser. No. 10/354,841, filed Jan. 30, 2003

### FIELD OF THE INVENTION

The present invention relates to a method for controlling the temperature inside a vehicle using a heating, ventilation, and air-conditioning system. In particular, the present invention relates to a method for controlling the temperatures of two or more separate zones in a vehicle with a heating, ventilation, and air-conditioning system.

### BACKGROUND OF THE INVENTION

A single-zone algorithm for controlling a vehicle heating, ventilation, and air-conditioning (HVAC) system for setting and maintaining a desired passenger compartment temperature has been described. The algorithm estimates the amount of heat gain or loss to the passenger compartment due to solar radiation and conduction heat transfer to the outside air. The algorithm then computes the amount of power for heating or cooling from the HVAC system required to balance the heat gain or heat loss to the passenger compartment.

Typically, the radiation heat transfer to the vehicle depends on the sun heat flux and the surface area exposed to the sun. The sun heat flux is usually measured using a solar intensity sensor. The conduction heat transfer is a function of the conduction heat transfer coefficient, the vehicle shell surface area, and the temperature gradient between the vehicle interior air and the outside ambient air. Both the interior air temperature and outside ambient air temperature are measured with sensors. Once the two heat transfer terms have been estimated, the temperature and airflow from the HVAC system necessary to balance the heat transfer can be computed. Vehicle air exits via exhaust valves and air leaks in the vehicle shell.

### BRIEF SUMMARY OF THE INVENTION

In one aspect, a method for controlling temperature inside a vehicle is provided that comprises determining a power required to control the temperature in a first zone of the vehicle and determining a discharge air temperature for one of the first zone and a second zone of the vehicle based on a mass transfer between the first zone and the second zone of the vehicle.

In another aspect, a method for controlling temperature inside a vehicle is provided that comprises measuring at least one parameter that includes outside ambient temperature, vehicle interior air temperature, and solar intensity; determining a power required to control the temperature in a first zone of the vehicle; determining a mass flow rate to the first zone from an empirical relationship between the power and the mass flow rate; setting the mass flow rate in the first zone equal to a mass flow rate of a second zone; determining each discharge air temperature for the first zone and the second zone of the vehicle using the power and mass flow rate for the first zone. Preferably, the method further comprises adjusting at least one blend door to achieve a desired discharge air temperature and/or controlling at least one blower motor to achieve the desired airflow.

In another aspect, a method for controlling temperature inside a vehicle is provided that comprises determining a first power required to control the temperature in a first zone and a second power to control the temperature in a third zone of the vehicle, determining a mass transfer in a second zone of the vehicle, and determining a discharge temperature for one of a first zone, second zone, and third zone of the vehicle based on the mass transfer between two zones selected from a group that includes the first zone, second zone, and third zone of the vehicle.

In another aspect, a method for controlling temperature inside a vehicle is provided comprising determining outside ambient temperature, vehicle interior air temperature, and solar intensity; calculating a solar intensity for a third zone based on a solar intensity for first and second zones; determining a first power to control the temperature in the first zone; determining an airflow in the first and second zones from an empirical relationship between the power required for the first zone and airflow in the first zone; determining a second power to control the temperature in the third zone; determining a second airflow for the third zone from an empirical relationship between the second power required for the third zone and the desired airflow in the third zone; determining a desired discharge air temperature for the first zone; determining a desired discharge air temperature for the second zone; determining a desired discharge air temperature for the third zone; positioning at least one blend door to achieve the desired discharge air temperature; and controlling at least one blower motor to achieve the desired airflows.

The discharge air temperature for each zone of the vehicle typically depends on parameters such as the target temperature for each zone, mass transfer due to an input and convection of air into the vehicle, and the area of a particular zone. In addition, the discharge air temperature, of a given zone may depend on at least one parameter that includes the thermal conductivity of a vehicle shell, surface area of a vehicle shell, effective glass area, specific heat of air, discharge air temperature, discharge airflow, outside ambient air temperature, and sun intensity. In a dual-zone system, the discharge air temperatures for the first and second zones depend also on the discharge air temperatures for the second and first zones, respectively. Preferably, the discharge air temperatures for the two or more zones are calculated iteratively to obtain final values of the discharge air temperatures of the two or more zones.

The mass transfer in the first zone is due to an input and convection of air inside the vehicle. In one aspect, the airflow of the first zone is set equal to the airflow of a second zone of a vehicle. Also, a vehicle interior temperature of the first zone can be set equal to a vehicle interior air temperature of the second zone. The algorithms described in more detail below may be used to control one or more temperatures in the various zones of a vehicle via a microprocessor in which one or more algorithms are stored.

### BRIEF DESCRIPTION OF THE DRAWINGS

FIG. 1 shows a single-zone algorithm control volume;

FIG. 2 shows a dual-zone algorithm control volume according to one aspect of the invention;

FIG. 3 shows a tri-zone algorithm control volume according to one aspect of the invention;

FIG. 4a shows a plot of airflow as a function of power;

FIG. 4b shows two equations illustrating an algorithm for determining power and temperature; and

FIG. 5 shows a tri-zone algorithm flow chart.

### DETAILED DESCRIPTION OF THE INVENTION

In the present invention, the vehicle interior is divided into two or more zones. The vehicle heating, ventilation, and air-conditioning (HVAC) system controls the temperature in each zone to a specified target value. As used herein, the subscripts D, P, and R refer to the driver, passenger, and rear zones of a vehicle, respectively.

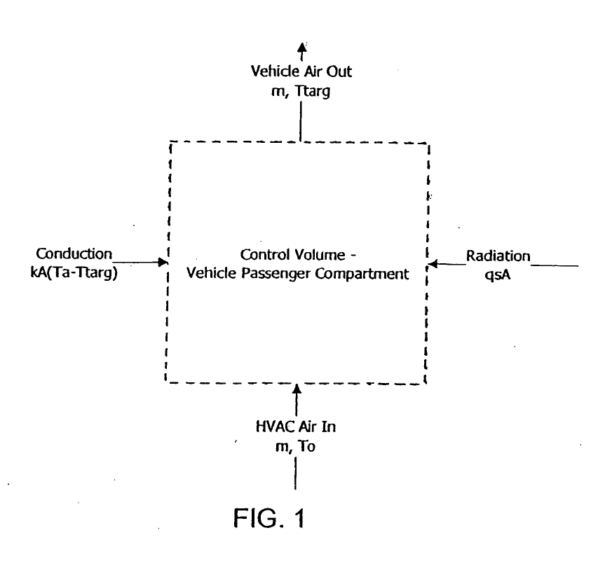

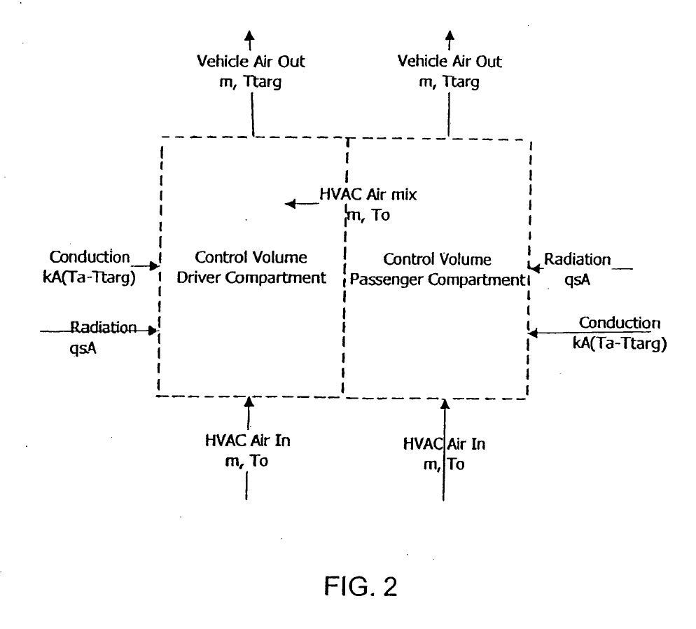

To solve this multi-zone problem, a control volume is drawn around each zone in the vehicle. FIG. 2 shows a control volume diagram for a dual-zone system. One zone is for the passenger side of the vehicle while the other is for the driver. The dual-zone system shown in FIG. 2 has the same radiation and conduction heat sources as the single-zone system shown in FIG. 1. However, an additional term is added to model the heat transfer between the two zones when the discharge air temperatures in the two zones are different.

Equations 1 and 2 are the energy balance Equations for the dual-zone control volumes. As used herein, mass transfer includes a mass flow rate of air and also includes a flux of other air-borne particles between the control volumes.
m_{D}C(T_{o,D}−T_{TARG,D})+m_{P-D}C(T_{o,D}−T_{o,P})=−KA′_{D}(T_{A}−T_{TARG,D})−q_{s,D}″A″_{D}+G(T_{TARG,D}−T_{INCAR,D}) Equation 1
mₚC(T_{o,P}−T_{TARG,P})−m_{P-D}C(T_{o,D}−T_{o,P})=−KA′ₚ(T_{A}−T_{TARG,P})−q_{s,P}″A″ₚ+G(T_{TARG,P}−T_{INCAR,P}) Equation 2
where:
m=mass transfer, in kg/s (calculated), in which m_{p-D} refers to the mass transfer between the passenger and driver's zones;
C=specific heat, in kj/kg-° K;
T₀=HVAC discharge (outlet) air temperature, in ° K (calculated);
T_{A}=side ambient air temperature, in ° K (measured from sensor);
T_{TARG}=get interior air temperature, in ° K;
T_{INCAR}=ual interior air temperature, in ° K (measured from sensor);
K=conduction heat transfer coefficient, in W/m²-° K (calibration constant);
q″ solar heat flux, in W/m² (measured from solar intensity sensor);
A′_{D}, A′_{P}=icle shell surface area for the driver or passenger side, in m² (calibration constant);
A″_{D}, A″_{P}=ective glass surface area for the driver or passenger side, in m² (calibration constant);
G=gain for proportional error (calibration constant).

The left hand sides of Equations 1 and 2 each contains two terms. The first term represents the heat transfer resulting from an airflow into the two control volumes provided by the HVAC system. The second term represents the heat transfer between the two control volumes, which is primarily driven by the mass transfer due to convection of the air in the vehicle compartment and the HVAC system airflow discharged into the vehicle compartment. It should be noted that one skilled in the art would know that mass transfer, airflow, mass flow rate and the like refer to a movement of mass over time, herein measured in kilograms per second (kg/s). The mass transfer between the control volumes is determined empirically. Mass transfer between the control volumes depends on the difference between the two discharge air temperatures of the HVAC system, the airflow from the HVAC system, outside ambient temperature, solar heat flux or intensity, and other factors that could influence the mass transfer between the zones inside the vehicle.

The following assumptions are made for a dual-zone algorithm: (1) there is only one vehicle interior air temperature sensor: T_{INCAR,D}=T_{INCAR,P}, where the subscripts D and P refer to driver and passenger, respectively; (2) there is only one HVAC blower motor and an airflow from the blower is equally split between the zones (M_{D}=M_{P}); (3) the airflow is determined based on the heating/cooling requirements of the driver; and (4) the area, A, represents the area of the driver or passenger side of the vehicle.

The equations can then be solved to determine the air temperature and airflow from the blower of the HVAC system necessary to control the air temperature within the zones of the vehicle to the target interior air temperature. First, a power required for controlling the temperature of the driver's side of the vehicle is computed. The power to control the driver's side temperature is given by the right hand side of Equation 2, and as shown in Equation 3 below is represented by “W” and is measured in watts. On the right hand side of Equation 3, the first term represents conductive heat transfer, the second term represents radiative heat transfer, and the third term represents an error term. An error term is often used to reduce the time required to reach steady state. A simple proportional gain term based on the difference between the target and actual temperatures inside the vehicle can be used for the error term.
W_{D}=−KA(T_{A}−T_{TARG,D})−q_{S,D}″A+G(T_{TARG,D}−T_{INCAR,D}) Equation 3

An empirical relationship between power required and airflow, which is represented by Equation 4 below, is used to obtain the airflow required from the blower.
m_{D}=m_{P}=f(W_{D}) Equation 4

The airflow from the blower of the HVAC system is calculated from the power required to control the temperature of the driver side of the vehicle based on the empirical relationship represented by Equation 4.

Many of the coefficients, constants, and tables can be obtained from computer simulations even before an actual vehicle or prototype becomes available for testing. This reduces the time required for market entry and the high cost associated with procuring and testing vehicles. With current computer technology, it is possible to create a three-dimensional finite element model of the vehicle interior air and shell. This model allows calculation of the heat transfer and mass transfer between the vehicle interior, vehicle shell, and outside air. Both steady state and transient simulations can be run on this model to compute the state of the air inside the vehicle (e.g., temperature, pressure, humidity) for a given set of boundary conditions (e.g., outside air temperature, vehicle speed, sun location and intensity). The steady state and transient simulations can also be run on this model to compute the vehicle climate control system settings (e.g., blower speed, discharge air temperature). Alternatively, the data is gathered by empirical testing or measurement.

From the above three-dimensional finite element model or measurements, the following constants can be obtained: vehicle shell surface area, vehicle shell conduction heat transfer coefficient (which accounts for both conduction and convection heat transfer), effective glass area (surface area of the vehicle interior exposed to the sun), and mass transfer between zones within the vehicle. The interfaces between zones in the vehicle can be modeled using “membranes,” which are virtual walls through which mass transfer can be calculated.

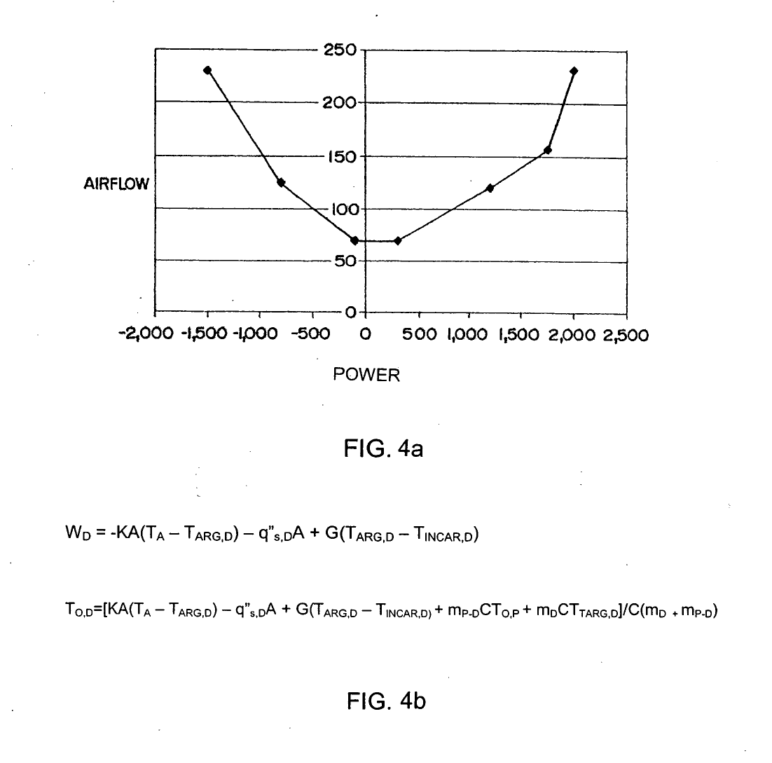

The final item for the calculation is the empirical relationship between power required to control the air temperature and airflow from the blower. An example of this empirical relationship is represented by the plot of airflow as a function of power shown in FIG. 4. This empirical relationship can also be represented in the form of a table, which can be adjusted or modified meet the preferences of particular customers or buyers.

Generally, when the vehicle interior is very hot or very cold the power required is high, and a high airflow from the blower is required to reach the target interior temperature within a relatively short time frame. For moderate interior temperatures, the required airflow is normally lower. However, high airflows tend to produce high noise levels inside the vehicle and should normally be avoided under moderate conditions. One may thus choose to reach a desired temperature quickly but at a high noise level, or obtain a desired temperature more slowly but at a lower noise level.

Equations 1 and 2 are respectively solved for the driver and passenger discharge air temperatures from the HVAC system. This yields Equations 5 and 6 below.
T_{o,D}.[−KA(T_{A}−T_{TARG,D})−q_{s,D}″A_{D}+G(T_{TARG,D}−T_{INCAR,D})+m_{P-D}CT_{O,P}+m_{D}CT_{TARG,D}]/C(m_{D}+m_{P-D}) Equation 5
T_{O,P}=[−KA(T_{A}−T_{TARG,P})−q_{s,P}″A_{P}+G(T_{TARG,P}−T_{INCAR,P})+m_{P-D}T_{O,D}+m_{P}CT_{TARG,P}.]/C(m_{D}+m_{P-D}) Equation 6

Equations 5 and 6 each contain two unknowns, T_{O,D} and T_{O,P}; the other terms are either measured values or calibration constants. The Equations can be solved once or iteratively to obtain final values for each discharge air temperature.

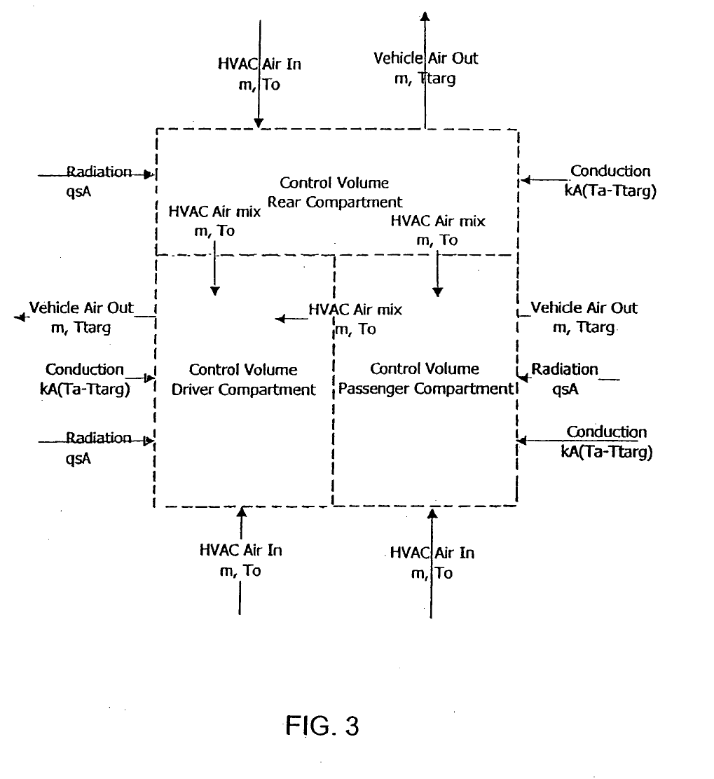

In another embodiment, the multizone system is a tri-zone system. In this system, the vehicle interior is divided into three zones or control volumes, and an HVAC system regulates the temperature in each zone to a desired target temperature. One zone is for the passenger side of the vehicle, one is for the driver, and the third for the rear of the vehicle. FIG. 3 shows a control volume diagram for a tri-zone system, which has the same radiation and conduction heat sources as the single-zone system shown in FIG. 1. However, an additional term is added to model the heat transfer between the zones in the tri-zone system when the discharge air temperatures in the zones are different.

Equations 7, 8, and 9 are the energy balance Equations for the three control volumes.
m_{D}C(T_{O,D}−T_{TARG,D})+m_{P-D}C(T_{O,D}−T_{O,P})+m_{R-D}C(T_{O,D}−T_{O,R})=−KA(T_{A}−T_{TARG,D})−q_{s,D}″A_{D}+G(T_{TARG,D}−T_{INC}) Equation 7
m_{P}C(T_{o,P}−T_{TARG,P})−m_{P-D}C(T_{O,D}−T_{O,P})+m_{R-P}C(T_{O,P}−T_{O,R})=−KA(T_{A}−T_{TARG,P})−q_{s,P}″A_{P}+G(T_{TARG,p}−T_{INC}) Equation 8
m_{R}C(T_{o,R}−T_{TARG,R})−m_{R-D}C(T_{O,D}−T_{O,R})−m_{R-P}C(T_{O,P}−T_{O,R})=−KA(T_{A}−T_{TARG,R})−q_{s,R}″A_{R}+G(T_{TARG,R}−T_{INC}) Equation 9

In contrast to the corresponding Equations for the dual-zone system, there are now three terms on the left hand side of each Equation. The first term represents the energy transfer from the airflow coming from the blower of the HVAC system into the control volume. The second two terms represent the heat transfer between the control volumes, which is primarily driven by the mass transfer due to the natural convection of air in the vehicle compartment and the HVAC system airflow discharged into the vehicle compartment. The mass transfer between the control volumes is determined empirically. The mass transfer is, for example, dependent on the difference between the driver and passenger discharge air temperatures, the airflow from the HVAC system blower, outside ambient temperature, solar intensity, and other factors that could influence the mass transfer between the zones inside the vehicle.

The following assumptions are preferably made for this algorithm: (1) a single vehicle interior air temperature sensor is shared by the driver and passenger control volumes and hence, T_{INCAR,D}=T_{INCAR-,P}; (2) the rear control volume has its own vehicle interior air temperature sensor; (3) a single front blower motor is shared by the driver and passenger control volumes, and the airflow from the blower is split equally, i.e., M_{D}=M_{P}.; (4) the rear control volume has its own rear blower motor; and (5) the airflow from the front blower is determined based on the heating/cooling requirements of the driver.

Equations 7, 8, and 9 can then be solved as follows. A first power required to control the temperature of the driver's side of the vehicle is computed. The first power is represented by W_{D} and corresponds to the right hand side of Equation 7, as shown by Equation 10 below.
W_{D}=−KA(T_{A}−T_{TARG,D})−q_{s,D}″A+G(T_{TARG,D}−T_{INCAR}) Equation 10

The empirical relationship as described above between power and airflow is used to obtain the airflow from the front blower. As discussed earlier, there is a single front blower motor and the airflow from the front blower motor will be computed based on the first power required to control the temperature of the driver side of the vehicle. An empirical relationship between the required power and airflow is represented by Equation 11 and is used to obtain the airflow required from the front blower.
m_{D}=m_{P}=f(W_{D}) Equation 11

Similarly, a second power required to control the temperature of the rear control volume and represented by W_{R} can be computed using Equation 12 below.
W_{R}=−KA(T_{A}−T_{TARG,R})−q_{s,R}″A+G(T_{TARG,R}−T_{INCAR,R}) Equation 12

An empirical relationship between the second power and airflow, which is represented by Equation 13 below, is used to obtain the airflow required from the rear blower for the rear control volume.
m_{R}=f(W_{R}) Equation 13

Next, Equations 7, 8, and 9 are solved to obtain the driver, passenger and rear discharge air temperatures, respectively. This step yields Equations 14, 15, and 16.
T_{O,D}=. [−KA(T_{A}−T_{TARG,D})−q_{s,D}″A_{D}+G(T_{TARG,D}−T_{INCAR,D})+m_{p-D}CT_{O,P}+m_{R-D}CT_{O,R}+m_{D}CT_{TARG,D}]/C(m_{D}+mₚ) Equation 14
T_{O,P}=[KA(T_{A}−T_{TARG,P})−q_{s,P}″A_{P}+G(T_{TARG,P}−T_{INCAR,P})+m_{P-D}CT_{O,D}+m_{R-P}CT_{O,R}+m_{P}CT_{TARG,P}]/C(m+mₚ) Equation 15
T_{O,R}=[−KA(T_{A}−T_{TARG,R})−q_{s,R}″A_{R}+G(T_{TARG,R}−T_{INCAR,R})+m_{R-D}CT_{O,D}+m_{R-P}CT_{O,P}+m_{R}CT_{TARG,R}]/C(m_{R}+mₚ) Equation 16

Equations 14, 15, and 16 each contain three unknowns, T_{O,D}, T_{O,P}, and T_{O,R}. The other terms are either measured values or calibration constants. These Equations can be solved once or iteratively to obtain final values for each of the discharge air temperatures.

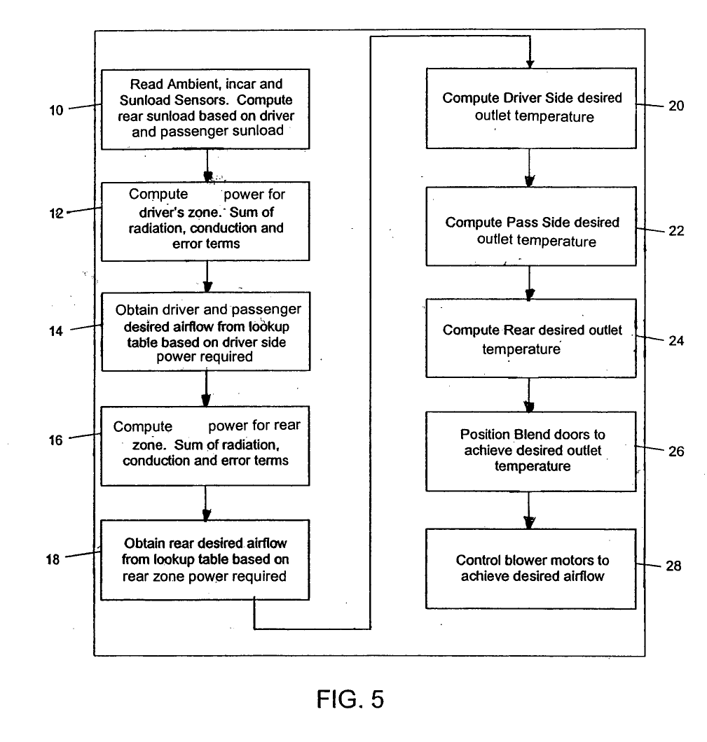

FIG. 5 shows an algorithm to obtain final values of each of the discharge air temperatures to control the air temperature in a tri-zone system. In this algorithm, a method for controlling temperature inside a vehicle is provided that includes reading outside ambient temperature, vehicle interior air temperature, and a sunload. The method also includes calculating a sunload for a third zone based on a measured sunload for a first and a second zone at box 10; calculating a first power to control the temperature for the first zone at box 12; obtaining a desired airflow into the first and second zones from an empirical relationship between the first power required for the first zone and airflow at box 14; calculating a second power for the third zone at box 16; obtaining a desired airflow into the third zone from an empirical relationship between power required for the third zone and airflow at box 18; calculating a desired discharge air temperature for the first zone at box 20; calculating a desired discharge air temperature for the second zone at box 22; calculating a desired discharge air temperature for the third zone at box 24; positioning at least one blend door to achieve the desired discharge air temperature at box 26; and controlling at least one blower motor to achieve a desired airflow at box 28. A blend door is typically a flap controlled by an electric motor and used to regulate a mixture of hot and cold air to produce a desired discharge air temperature. Different configurations of blend doors, or their equivalents, may be used.

An example embodiment is described below. This example is one of many embodiments and is merely illustrative.

### EXAMPLE

This example describes an application of the tri-zone algorithm discussed above. The sample system can be an SUV or another vehicle with driver, passenger, and rear zones. The vehicle occupants can select separate target temperatures for each of the three zones via one or more climate control module(s). The system includes the following:

(a) front air handling units that includes 1 blower and 2 temperature doors;

(b) rear air handling units that includes 1 blower and 1 temperature door;

(c) 1 vehicle interior air sensor located on driver's side of instrument panel;

(d) 1 vehicle interior air sensor for the rear zone;

(e) 1 outside ambient air temperature sensor; and

(f) 2 solar intensity sensors located on the dashboard (e.g., one on the driver's side, another on the passenger's side).

For the above system, the following calibration constants are used:

(a) thermal conductivity of the vehicle shell;

(b) surface area of the vehicle shell (for conduction heat transfer calculation);

(c) effective glass area (for radiation heat transfer calculation);

(d) power-versus-airflow curve for the front blower;

(e) power-versus-airflow curve for the rear blower;

(f) mass transfer between driver and passenger zones;

(g) mass transfer between driver and rear zones;

(h) mass transfer between passenger and rear zones; and

(i) specific heat of air.

Because only one blower motor is used in the above system for the two front zones, the blower speed is set according to the heating/cooling needs of the driver. There is no vehicle interior air sensor for the passenger zone. The passenger zone uses the driver side vehicle interior air sensor reading. Algorithms can be developed to infer actual passenger side vehicle interior air temperature based on driver side vehicle interior air temperature and other factors. In the above system, no rear solar intensity sensor is used. The rear solar intensity is computed based on a combination of readings from the passenger and driver zones.

Typical blower curves yield large airflows in extreme heating and cooling conditions and moderate airflows when the vehicle interior air temperature is near the set point temperature. FIG. 4 shows an example of a blower curve.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A method for controlling temperature inside a vehicle comprising:
(a) determining a power for a first zone of the vehicle; and
(b) determining a discharge air temperature for one of the first zone and a second zone of the vehicle using a mass transfer between the first zone and the second zone of the vehicle.

2. The method of claim 1, further comprising obtaining a mass transfer in the second zone.

3. The method of claim 1, wherein the discharge air temperature is determined using the power and the mass transfer in the first zone.

4. The method of claim 1, wherein the mass transfer is determined from an empirical relationship between power and mass transfer.

5. The method of claim 1, wherein the discharge air temperature for each zone depends on a target temperature for each zone.

6. The method of claim 1, wherein the power is determined using at least one parameter selected from a group consisting of outside ambient temperature, vehicle interior temperature, and solar intensity.

7. The method of claim 1, wherein the discharge air temperature of a zone depends on a mass transfer due to an input and convection of air into the vehicle.

8. The method of claim 1, wherein the discharge air temperature of a zone depends on an area of the zone.

9. The method of claim 1, wherein the mass transfer in the first zone is due to an input and convection of air inside the vehicle.

10. The method of claim 1, wherein a vehicle interior air temperature of the first zone is determined based on a vehicle interior air temperature of the second zone.

11. The method of claim 1, wherein the discharge air temperature of a zone depends on the discharge air temperature of another zone.

12. The method of claim 1, wherein the discharge air temperature of a zone depends on at least one parameter selected from a group consisting of thermal conductivity of a vehicle shell, surface area of a vehicle shell, effective glass area, specific heat of air, discharge air temperature, discharge airflow, outside ambient temperature, and solar intensity.

13. A method for controlling temperature inside a vehicle comprising:
(a) determining a power for a first zone and a third zone of the vehicle;
(b) obtaining a mass transfer in a second zone of the vehicle; and
(c) determining a discharge temperature for one of the first zone, second zone, and third zone of the vehicle based on a mass transfer between two zones selected from a group consisting of the first zone, second zone, and third zone of the vehicle.

14. The method of claim 13, wherein the mass transfer is determined from an empirical relationship between mass transfer and power.

15. The method of claim 13, wherein the power is determined using at least one parameter selected from a group consisting of outside ambient temperature, vehicle interior air temperature, and solar intensity.

16. The method of claim 13, wherein the discharge air temperature of a zone depends on a target temperature for the zone.

17. The method of claim 13, wherein the discharge air temperature of each zone depends on a mass transfer due to an input and convection of air into the vehicle.

18. The method of claim 13, wherein the discharge air temperature of a zone depends on an area of the zone.

19. The method of claim 13, wherein the discharge air temperature for a zone depends on a discharge temperature of at least one other zone.

20. The method of claim 13, wherein the discharge air temperature of a zone depends on at least one parameter selected from a group consisting of thermal conductivity of a vehicle shell, surface area of a vehicle shell, effective glass area, specific heat of air, discharge air temperature, discharge airflow, outside ambient temperature, and solar intensity.
